(19) United States
(12) Patent Application Publication
(10) Pub. No.: US 2008/0028294 A1
(43) Pub. Date: Jan. 31, 2008

(54) METHOD AND SYSTEM FOR MANAGING AND MAINTAINING MULTIMEDIA CONTENT

(75) Inventors: Lorenz Sell, Honolulu, HI (US); Jason Skicewicz, Honolulu, HI (US); Nesan Waran, Honolulu, HI (US); Earle Ady, Alexandria, VA (US); Yasu Nagaoka, Saratoga, CA (US); Henk Rogers, Honolulu, HI (US)

Correspondence Address: STRATEGIC PATENT GROUP, P.C., P.O. BOX 1329, MOUNTAIN VIEW, CA, 94042, US

(73) Assignee: BLUE LAVA TECHNOLOGIES, Honolulu, HI (US)

(21) Appl. No.: 11/828,840

(22) Filed: Jul. 26, 2007

Related U.S. Application Data
(60) Provisional application No. 60/833,882, filed on Jul. 28, 2006.

(51) Int. Cl. G06F 15/00

(52) U.S. Cl. 715/234; 715/200

(57) ABSTRACT

A method and system for displaying and organizing content are described. In one aspect, the method and system include an embeddable display widget that receives content pushed to the display widget, provides input regarding the content, and plays the content. In another aspect, the method and system provide content to a page. In this aspect, the method and system include providing container(s) for storing content, providing an interface, and providing a plurality of commands. The interface includes first and second modules for pushing content to and listening for input from the page. The commands are for accessing the content in the container and for providing the content to the page based on the input. In another aspect, the content includes items stored in a container. In this aspect, the method and system include displaying item(s), allowing a user to provide input regarding at least some item(s), sorting the item(s) based on the input, and displaying the item(s) based on the input.

### CROSS-REFERENCE TO RELATED APPLICATIONS

This application claims the benefit of provisional Patent Application Ser. No. 60/833,882, filed Jul. 28, 2006, assigned to the assignee of the present application, and incorporated herein by reference.

### BACKGROUND OF THE INVENTION

The challenge of managing content, including but not limited to multimedia content such as audio, video, and image data, has spawned numerous websites. For example, one conventional site allows users to generate a loop of digital images. An owner of the images generates a loop by downloading and using a software client. This loop of images may then be played in a display widget. The loop can be posted on the owner's website or desktop or otherwise shared with other users. Authorized users having the software client can also add their images to the loop. Consequently, image content can be shared and altered provided the same software client is downloaded by multiple users. Another site, slide.com allows an owner to create a slideshow of images only. Authorized users can view and comment on the content created by the owner. However, comments can be made only on the slideshow in its entirety. Similarly, abazab.com provides a playbox that acts as a player, recorder, and storage for video content. An owner of video can share the video. In addition, authorized users can also add video clips to the playbox. Another, digg.com, manages news data. On this site, links to various news stories are provided. Users of digg can read and rate news stories. Users are directed to specific stories based on criteria such as rating and story date.

Although mechanisms for managing content over the Internet exist, one of ordinary skill in the art will readily recognize that there are drawbacks to each. For example, limitations in the functionality or the use of software clients may be undesirable. In addition, community based review of data is increasingly desired. Accordingly, what is needed is a method and system for managing multimedia data. The method and system disclosed herein address such a need.

### BRIEF SUMMARY OF THE INVENTION

A method and system for displaying and organizing content are described. In one aspect, the method and system include display widget that is embeddable on a page. The display widget receives content pushed to the display widget, provides input regarding the content, and includes a player for playing the content. In another aspect, the method and system provide content to a page. In this aspect, the method and system include providing at least one container for storing content, providing an interface, and providing a plurality of commands. The interface includes a first module for pushing content to the page and a second module for listening for input from the page. The plurality of commands is for accessing the content in the container and for providing the content to the page based on the input from the page. In another aspect, the content includes a plurality of items stored in a container. In this aspect, the method and system include displaying at least one of the plurality of items and allowing a user to provide input regarding at least a portion of the plurality of items. In this aspect, the method and system also include sorting the plurality of items based on the input and displaying the plurality of items based on the input.

According to the method and system disclosed herein, interaction between users and content facilitated.

### BRIEF DESCRIPTION OF SEVERAL VIEWS OF THE DRAWINGS

FIG. 1 is a high-level block diagram depicting an exemplary embodiment of a system for managing data, particularly multimedia data.

FIGS. 2-7 are diagrams depicting exemplary embodiments of systems or portions of systems for utilizing an embeddable display widget in accordance with the method and system.

FIGS. 8-12 depict exemplary embodiments of systems and a method for performing social content aggregation.

FIGS. 13-19 depict exemplary embodiments of systems and methods for performing automatic selection of a subset of available content for presentation.

FIG. 20 depicts an exemplary embodiment of a method for performing automatic selection of a subset of available audio content for presentation.

FIGS. 21-25 depict exemplary embodiments of systems and a method for determining and displaying items utilizing ambient color framing.

FIGS. 26-28 depict exemplary embodiments of a system for use in comment and rating.

FIGS. 29-30 depict exemplary embodiments of a method and system for displaying content based on it ranking.

### DETAILED DESCRIPTION OF THE INVENTION

The method and system relate to maintenance management of content, particularly through communication over the Internet or other network. The following description is presented to enable one of ordinary skill in the art to make and use the method and system and is provided in the context of a patent application and its requirements. Various modifications to the embodiments and the generic principles and features described herein will be readily apparent to those skilled in the art. The system and method are described in the context of particular block diagrams and flow charts. However, one of ordinary skill in the art will readily recognize that steps and/or blocks may be omitted and/or combined in other embodiments. One of ordinary skill in the art will recognize, however, that other implementations having different, fewer, and/or additional functionality not inconsistent with the method and system may be used. Thus, the method and system are not intended to be limited to the embodiments shown, but is to be accorded the widest scope consistent with the principles and features described herein.

A method and system for displaying and organizing content are described. In one aspect, the method and system include display widget that is embeddable on a page. The display widget receives content pushed to the display widget, provides input regarding the content, and includes a player for playing the content. In another aspect, the method and system provide content to a page. In this aspect, the method and system include providing at least one container for storing content, providing an interface, and providing a plurality of commands. The interface includes a first module for pushing content to the page and a second module for listening for input from the page. The plurality of commands is for accessing the content in the container and for providing the content to the page based on the input from the page. In another aspect, the content includes a plurality of items stored in a container. In this aspect, the method and system include displaying at least one of the plurality of items and allowing a user to provide input regarding at least a portion of the plurality of items. In this aspect, the method and system also include sorting the plurality of items based on the input and displaying the plurality of items based on the input

The method and system are mainly described in terms of particular systems provided in particular implementations. However, one of ordinary skill in the art will readily recognize that this method and system will operate effectively in other implementations. For example, portions of the method and system may be described in the context of a remotes system, which may be accessed through a network such as the Internet, and/or a remote system. However, one of ordinary skill in the art will recognize that the method and system may be utilized in other systems. Thus, the systems, devices, and networks usable with the method and system can take a number of different forms. The method will also be described in the context of certain steps. However, the method and system operate effectively for other methods having different and/or additional steps not inconsistent with the present invention. Further, the steps in the method may be performed in a different order, including in parallel. In addition, although the method and system may be described with respect to single items, one of ordinary skill in the art will recognize that the method and system also operate effectively for multiple items. In addition, the method and system are described in the context of items, such as images or video. As used herein, an item of content may include content such as images, sound, video, audio, and/or other multimedia content. In some embodiments, multiple images, for example a video clip, sound, and/or other content may also be part of the item. One of ordinary skill in the art will recognize that images include photos. A photo may include a full resolution version of the image, or a smaller, lower resolution of the photo typically known as a thumbnail. One of ordinary skill in the art will also recognize that although multimedia content includes images, the method and system may be used for other multimedia content, such as video clips.

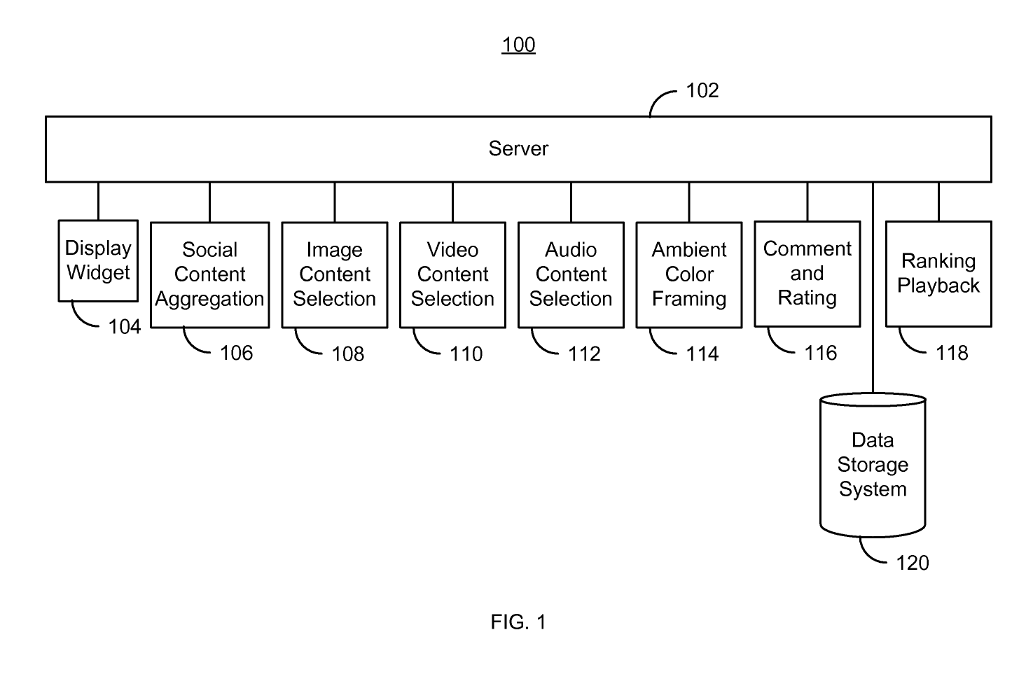

FIG. 1 depicts an exemplary embodiment of a system 100 for managing and maintaining data, particularly multimedia content. Multimedia content may include items having one or more of images, video, text, and audio. In the embodiment, shown, the system 100 includes a server 102 utilizing a display widget 104, social content aggregation subsystem 106, image content selection subsystem 108, video content selection subsystem 110, audio content subsystem 112, ambient color framing subsystem 114, comment and rating subsystem 116, and ranking playback subsystem 118, as well as a data storage system 120 that may be a database. In another embodiment, one or more of the components 102, 104, 106, 108, 110, 112, 114, 116, 118, and 120 may be omitted or moved to be remote from other component(s) 102, 104, 106, 108, 110, 112, 114, 116, 118, and 120. The data storage system 120 may include containers, discussed below. Thus, the system 100 may be used to archive content such as audio, video, and digital images. The content archived in the data storage system 120 may be managed using one or more of the components 104, 106, 108, 110, 112, 114, 116, and 118. Although depicted as separate components, the display widget 104, social content aggregation subsystem 106, image content selection subsystem 108, video content selection subsystem 110, audio content subsystem 112, ambient color framing subsystem 114, comment and rating subsystem 116, and ranking playback subsystem 118 may interact and/or may be combined in other modules (not shown). For example, the social content aggregation subsystem 106 might utilize the display widget 104 for purposes such as providing output. Moreover, input may be accepted from pages (not shown) including the display widget 104 without leaving the web page. In addition, although the display widget 104, social content aggregation subsystem 106, image content selection subsystem 108, video content selection subsystem 110, audio content subsystem 112, ambient color framing subsystem 114, comment and rating subsystem 116, and ranking playback subsystem 118 are depicted, other embodiments of the system 100 may contain a subset of the components 104, 106, 108, 110, 112, 114, 116, and 118 and/or may include additional components and functionality (not shown). In addition, one of ordinary skill in the art will readily recognize that other embodiments not inconsistent with the present invention may be utilized. The aspects 104, 106, 108, 110, 112, 114, 116, and 118 are, however, described separately below.

The system 100 may be used to store and manage content, such as items including one or more of images such as photographs, video, and audio. In one embodiment, the content may be accessed via a web page (not shown). Such content may be provided to the system 100 via display widget 104 on the page or through another source including but not limited to other computer systems, email, and cell phones. The system 100 may archive and selectively present the content to user(s) via the web page. In presenting the content to the users, the system 100 utilizes one or more components 104, 106, 108, 110, 112, 114, 116, and 118. In addition to allowing content to be uploaded by a user through the display widget 104 without leaving the page or other means, certain other users may also upload content through the display widget 104 without leaving the page or other means. Thus, the system 100 allows a community to aggregate the content. Furthermore, the system 100 allows a community of users to evaluate the content, in one embodiment through a hosted page. In one embodiment, individual items of content as well as collections of the content may be ranked. By collecting content in one or more related containers, a channel of content may be created through the system 100 to accommodate special interests of communities. The system 100 also allows subsets of content to be automatically selected and presented to users based on specific criteria. For example, video clips and/or images may be selected based upon the criteria and presented to the user in the form of a video and/or slide show. The users may then comment on and rank the content. In one embodiment, individual items of content such as a video clip or image, and/or the video and/or slideshow as a whole may be ranked and commented on. Moreover, the system 100 may present items to the user in a more desirable manner, for example by selecting an ambient background color based on the images or video and/or sizing the content based upon the community's evaluation of the content. The functions of the system 100 are described below.

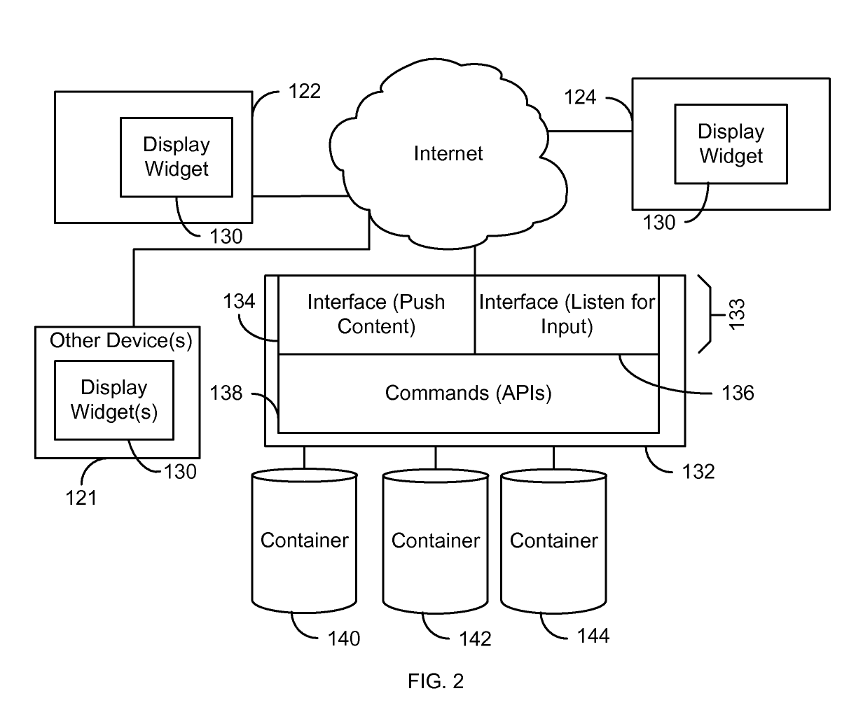

FIGS. 2-7 depict exemplary embodiments of systems for utilizing a multimedia display widget. Referring to FIGS. 2-7, the system depicted in FIG. 2 includes at least a display widget 130, a container (such as the container 140), the interface 133 and commands 138 through which the container 140 is accessed. The display widget 130 is embeddable in a page, such as the page 122 and/or 124 and subscribes to a container 140, 142, or 144 through the server 132. For the purposes of discussion, it is assumed that the display widget 130 subscribes to the container 140. In one embodiment, the display widget 130 is an embeddable script that can be embedded on any html page. For example, the display widget may be embedded on any website supporting html or flash input. In addition, the display widget 130 may be embedded on multiple pages 122 and 124 to provide content to multiple pages substantially simultaneously. The display widget 130 may utilize a flash player 146. The display widget 130 may utilize a user interface 131 for allowing the user to play content and, in one embodiment, upload to the container 140. Consequently, the display widget 130 may provide interactivity with the user of the page 122 and/or 124 including uploading content to the container 140 without leaving the page 122 and/or 124. As a result, multiple individuals on multiple pages 122 and/or 124 may not only view the content of the container 140, but also upload to the container 140. Moreover, in one embodiment, the display widget 130 can be extended to other media. Such a display widget 130 may allow the contents of the container 140 to be broadcast over multiple media. For example, a display widget 130 might provide the contents of the container 140 substantially simultaneously across the web (e.g. through pages 122 and/or 124), mobile networks, and/or cable television networks (collectively shown as other devices 121 in FIG. 2). Although the other devices 121 are shown as being connected through the Internet, in another embodiment, another mechanism for connecting the other device(s) with the server 132 might be utilized. The display widget 130 may also allow input from other media, for example through the GUI of a mobile phone or via the remote control of a television. Thus, two-way interactivity (viewing and uploading) through the display widget 130 may be extended to multiple media, allowing multiple users to cross-broadcast to each other.

The display widget 130 subscribes to a container 140, 142, and/or 144. For the purposes of discussion, the content 140 will be described. However, in another embodiment, the display widget 140 might subscribe to one or more of the containers 140, 142, and 144. If the display widget 130 subscribes to the container 140, the display widget 130 plays the content from the container 140 on the page 122 and/or 124 in which the display widget 130 is embedded. Thus, the container 140 archives data played on the display widget 130 and associated data such as users authorized to add content to the display widget 130 and/or to view the contents of the display widget 130. The container 140 may be considered to be owned by a user that controls the list of authorized users. The authorized users may include only an individual, a specified group of individuals, or all possible users. In addition, the authorized users for viewing content of the container 140 may be different from the authorized users for adding content to the container 140. In one embodiment, the data, otherwise termed content, playable by the display widget 130 may include images such as digital photos, video, audio, and text.

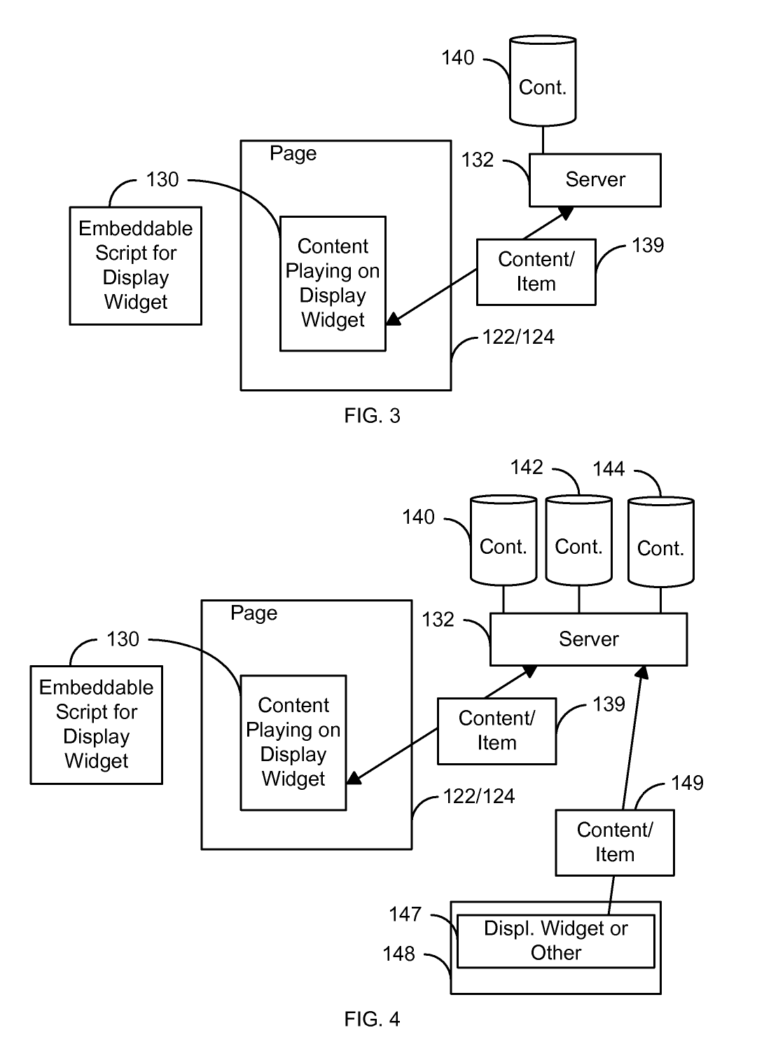

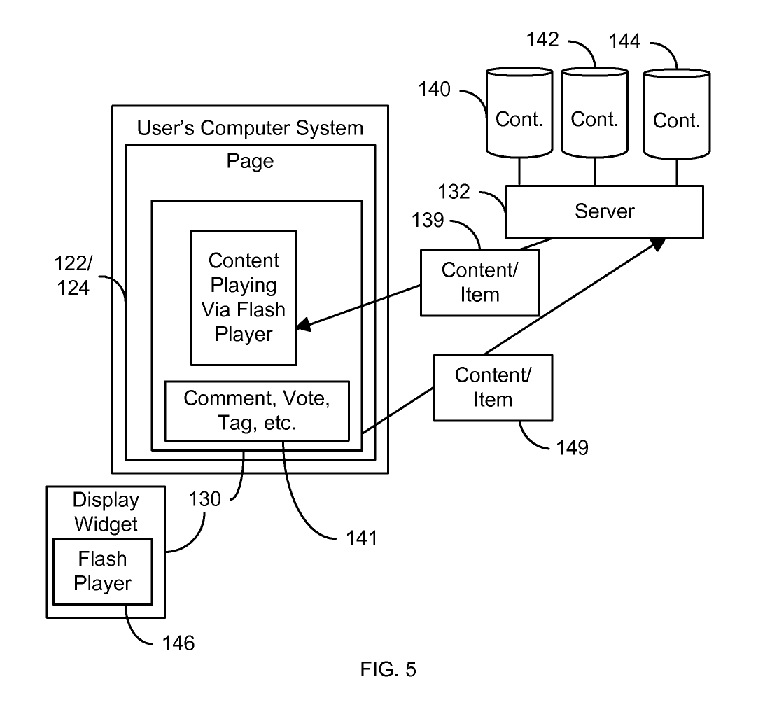

For example, FIGS. 3-6 depict exemplary embodiments of the display widget 130 as it displays content on the page 122/124. Referring to FIG. 3, the content 139 from the container 130 may be pushed by the server 132 to the display widget 130. FIG. 4 depicts a situation similar to that shown in FIG. 3 in that content 139 from a container 140, 142, and/or 144 may be displayed on the page 122/124 by the display widget 130. In addition, content 149 may be uploaded from another computer system 148. The other system 148 may upload the content through a system 147, which may be the display widget 130 or other mechanism. In addition, if authorized, the content 149 may be provided to the display widget 130 and thus shown on the page 122/124. Similarly, FIG. 5 depicts an exemplary embodiment of system in which the content 139 is provided to the display widget 130 and played on the page 122/124 via a flash player 146. In the embodiment shown in FIG. 5, the display widget 130 is also used to upload content 149 from page 122/124.

Because the display widget 130 subscribes to the container 140, the display widget 130 may automatically update to play new content added to the container 140. The data may be provided to the container 140 through the widget 130, as described below. In addition, content may be provided to the container 140 through another computer system 148, or other mechanism (121/147 such as a flash widget, a mobile phone via MMS, a third party site, and/or email. Via the Internet or other network, the display widget 130 accesses the content in the container 140 through the interface 133 and commands 138 of the server 132. Thus, multiple users of multiple pages 122 and 124 or other media may cross-broadcast by uploading content to the same container 140, which is automatically broadcast through the display widget 130.

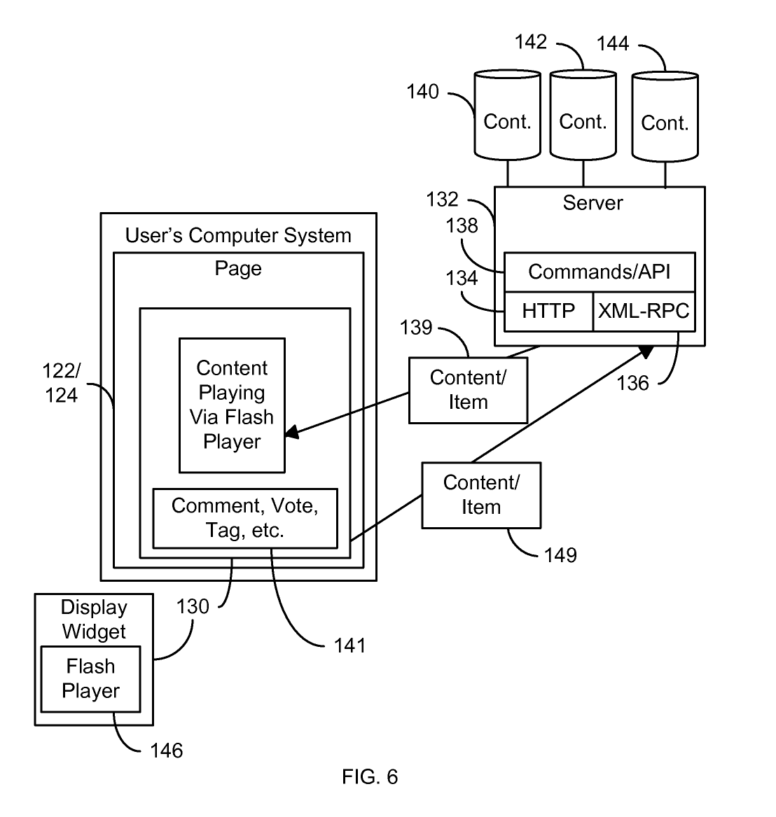

The display widget 130 communicates with interface 133 and utilizes commands 138 that reside on a server 132. The interface 133 includes portions 134 and 136 that allow data to be provided to the display widget 130 and input to be received from the display widget 130. In one embodiment, depicted in FIG. 6, the interface portions 134 and 136 utilize HTTP protocol and XML-RPC protocols, respectively. Thus, the interface portion 134 may push content to the display widget 130, while the interface portion 136 listens for input from the display widget 130. The commands 138 may take the form of APIs used to obtain data from or provide data to the appropriate containers 140 and 142. For example, the commands 138 may include get or add commands for users and/or items. This technology may be extended to other media, such as cell phones or television, in order to provide input to and receive input from users of other media via the display widget 130.

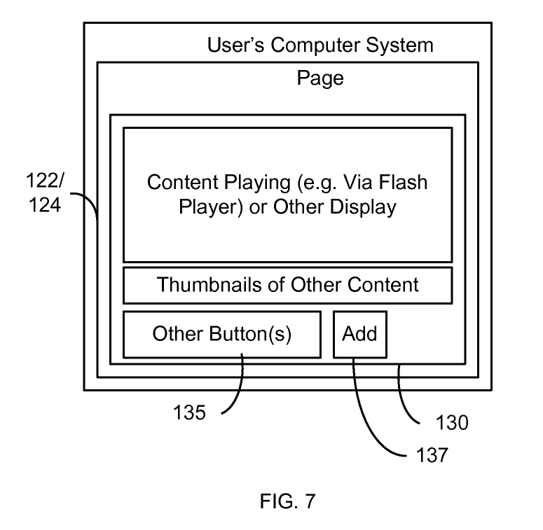

As discussed above, data uploaded to the container 140 from the display widget may include additional content, such as images or video, playable on the display widget 130. For example, as shown in the exemplary embodiment of FIG. 7, additional buttons 135 may be provided. For example, a user may click on the “Add″” button 137 to add an image to the container 140. If the user is authorized by the owner of the container 140, then the image will be added to the container. The display widget 130 may then automatically update the content to include the new image in a slideshow played to a user of the page 122 and/or 124. In addition, other content, particularly that described below in the context of social content aggregation and comment and ranking, may also be provided. For example, the user of the page 122 and/or 124 may be allowed to comment on items played by the display widget 130, vote on items played by the display widget 130, and tag items played by the display widget 130. In one embodiment, the user of the page 122 and/or 124 may be allowed to comment, tag, or vote on individual items in the slideshow as well as the slideshow in its entirety.

Thus, using the system and method including the display widget 130, the contents of any container 140 to which the display widget 130 subscribes may be displayed on any page supporting html or flash input, updates to these contents may be automatically accessed and displayed, and a user may be allowed upload to the container without leaving the page on which the display widget 130 is embedded. This is possible without requiring a software client to be downloaded.

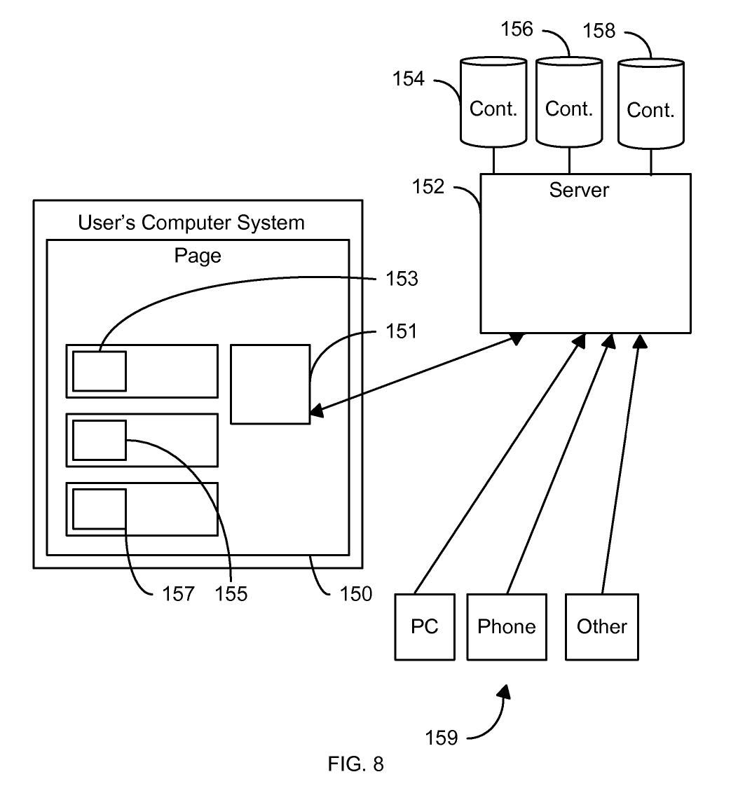

The social content aggregation subsystem 106 allows for multiple users to organize content on a hosted multimedia platform. FIGS. 8-12 depict exemplary embodiments of systems and a method for performing social content aggregation. Referring to FIG. 8, the systems include a hosted platform, for example using a server 152 and containers 154, 156, and 158 that are accessible through a web page 150. To allow for social content aggregation, one or more containers 154, 156, and 158 are created for an individual or community. For the purposes of discussion, it is assumed that one container 154 is created for a particular community. The container 154 may be considered to be a database accessible through the server 152 and displayed to the user via a page 150 including a display widget 151 that plays the content. In one embodiment, the display widget 151 is analogous to the display widget 130 described above. Thus, in embodiment, content may be added to the container 154 without leaving the page 150. In such an embodiment, interface(s), such as the interfaces 134 and 136 using HTML and XML-RPC protocols, may be used by the server 152 to push content to and listen for input from the page 150. However, in an alternate embodiment, another display widget (not shown) may be used. For clarity, the method and system are described in the context of the container 154. However, in another embodiment, the container 154, 156, and/or 158 might be used. The contents of the container 154 may be uploaded using a number of devices 159 such as a personal computer, camera phone, or via the display widget 151. In one embodiment, only the owner of the container is the only user who is authorized to add multimedia content such as additional photos, video, and audio to the container. However, in one embodiment, the authorized users for adding multimedia content include a larger number of individuals, as described above. In one embodiment, multiple users are authorized to add content such as images, video and audio. Also in such an embodiment, multiple users are authorized to evaluate the content. For example, multiple users may be allowed to view, rank, comment on, and tag individual items in the container 154 or groups of items in the container 154. Based on the evaluation by the users, the page 150 may be updated to reflect the new content and evaluation of the content by the users.

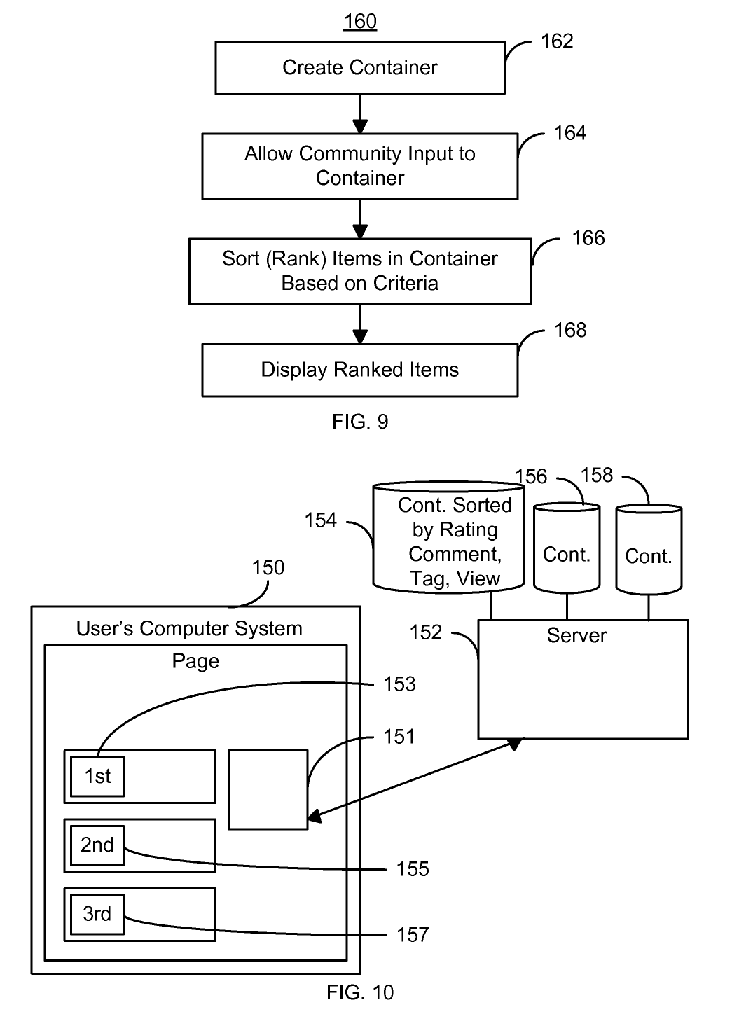

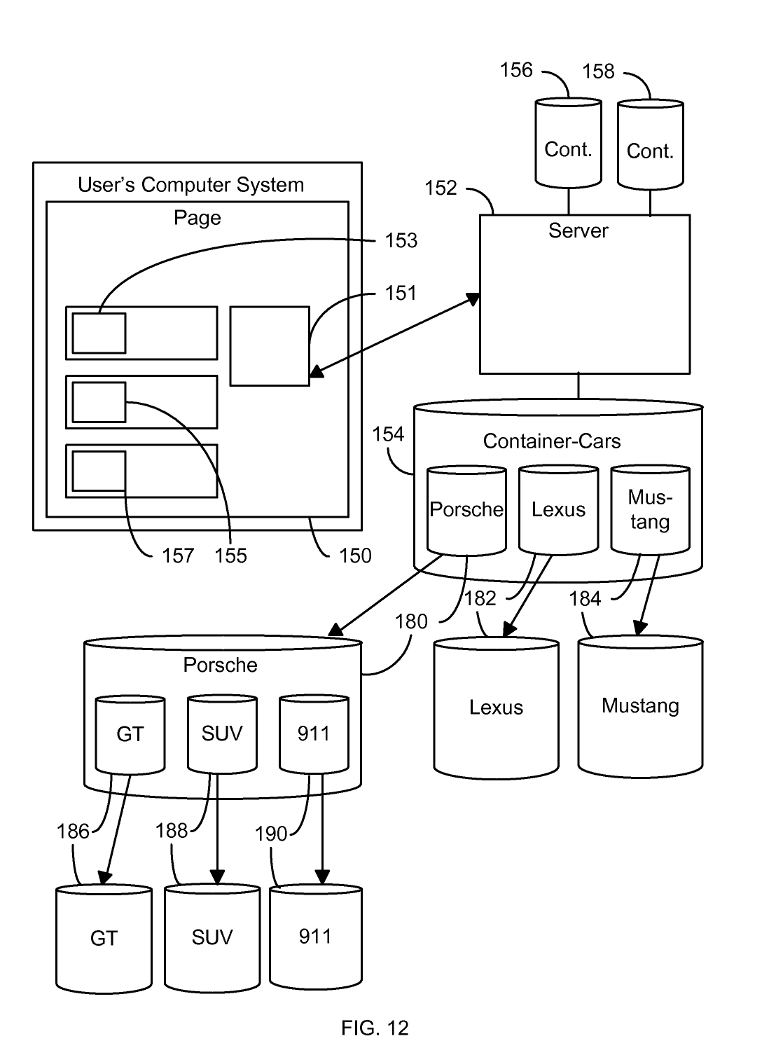

For example, FIG. 9 depicts an exemplary embodiment of a method 160 for evaluating content. Although the method 160 is primarily described in the context of a single container, the method 160 may be used to allow users to evaluate the contents of multiple containers. One or more container(s) 154 is created, via step 162. The container may be used to archive the content, such as multimedia content. In one embodiment, the container 154 relates to a particular community and is a hosted container. Step 162 may also include defining the community, for example by restricting authorized users for adding content, commenting or providing other input, and/or viewing. The community may be as small as a single individual (e.g. the owner) or as large as any individual desiring to access the container. For example, an owner of the container 154 might create a container of images for a wedding and the community may include attendees of the wedding and other friends and/or relatives of the bride and groom. Thus, authorized users for both viewing and adding images may be restricted to specific individuals. In step 162, the owner may also place initial content in the container, such as video, photos or images of the bride, groom, and related individuals or places. In another embodiment, the user may create the container and be the only individual authorized to add multimedia content, but allow any individual to view and evaluate the multimedia content in the container. Step 162 also may include associating a display widget 151 with the container 154. In addition, step 162 may include creating multiple related containers. For example, the containers may be related by nesting the containers, as discussed below with respect to FIG. 12. Thus, a relevant community may effectively be defined by the contents of a single container or multiple related containers.

Other users in the community are allowed input to the container(s), via step 164. Step 164 may include utilizing the system 100 to display the content in the page 150. The page may display individual items in the container 154, such as in portions 153, 155, and 157 of the page 150. In addition, a display widget 151 may be used to display content such as a slide show. The items in the slide show may be selected using subsystems 108, 110, 112, and displayed using systems 114 and 118, described below. The users may be allowed to add content such as images, audio, video, or other input. In one embodiment, this is accomplished without leaving the page 150. Through the web page, users in the community may be allowed to view, comment on, rank, and tag individual items in the container 154 as well as the amalgam of the content displayed through the display widget 151 or otherwise provide input regarding the contents of a container 154. In addition, the user may also be allowed to comment on, rank, or otherwise provide input for multiple related containers in step 164. Thus, the contents of each of the containers as well as the entire containers may be commented on and ranked in step 164.

The content is sorted based on criteria, via step 166. Step 166 may include sorting the content based on the rating, comments, tags, views presented, or some combination thereof. The owner of the container(s) or other authorized individual may select the combination of criteria and/or weighting for sorting the content in step 166. In addition to sorting the content in individual containers, in some embodiments, different containers may also be sorted based on the input provided in step 164. For example, if a community, or network, of containers is ranked, then the containers may be sorted based on the ranking. The containers may also be sorted based on the rankings of items within the container. Similarly, the number of links to each container or items in the container may be used in sorting the containers and/or contents within the containers. Thus, not only the items in an individual container can be sorted, but also the containers themselves. The sorted content may be displayed, via step 168. For example, the highest ranked images may be presented in regions 153, 155, and 157 of the page 150. An exemplary embodiment of such a situation is depicted in FIG. 10. The highest ranked image or other item of content from container 154 is depicted in region 153, the next highest is shown in region 155, and the third highest in region 157. Similarly, higher ranked slide shows and/or video clips may be automatically displayed using the display widget 151. Users in the community may also be directed to unviewed content in order to facilitate ranking of the content. Similarly, higher ranked containers may be delivered. The result is that the best content of individual containers or a group of containers may float to the top and be more visible to users. Thus, a community for particular interests may be created through an individual container and/or a set of containers. Because multiple containers may be used, any interests, including those only for a small community, may be represented. The contents of the container(s) may be filtered using the input (e.g. commenting and ranking) process in order to determine the best material in the container(s). The community-determined best material in the container(s) may be delivered. Consequently, a community multimedia recommendation is effectively provided, based on the preferences of the majority, for both small and large communities.

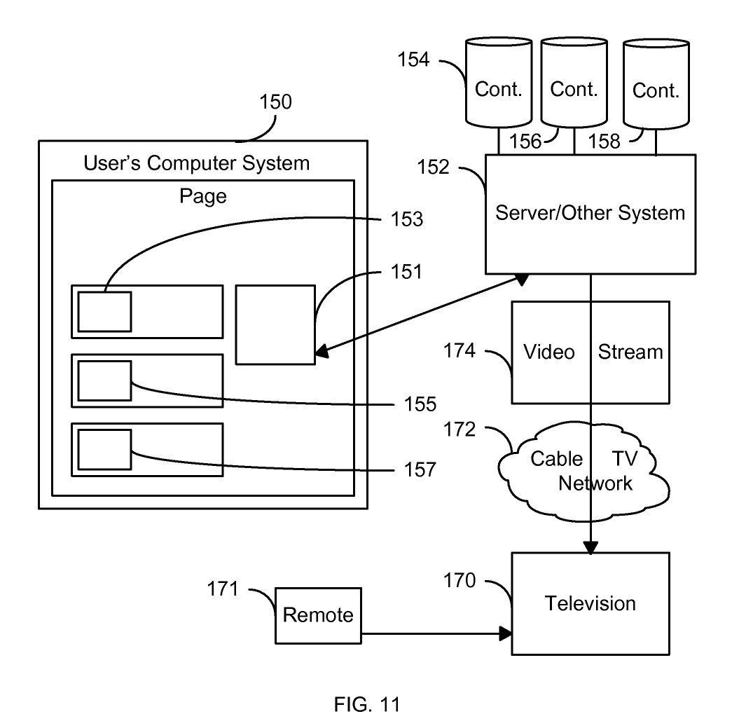

Although described in the context of a computer network alone, the method 160 and system 100 may be applied to technology such as television. An exemplary embodiment one such system is depicted in FIG. 11. Content in a container 154 and/or 156 may be presented to users via television 170, depicted in FIG. 11. In particular, a video stream 174 may be generated by the system 152 and provided to the television, for example via a cable television network 172. Users may vote or rank the content using a remote control 171. The content in the container 154 and/or 156 may then be sorted and again streamed to a television network (e.g. a cable network). As a result, a channel of content specific to, evaluated by, and reflecting the preferences of a community may be created.

In addition, containers such as the containers 154, 156, and 158 (as well as containers 140, 142, and 144) may be embedded within other containers to accommodate more special interests within communities. Web pages and/or display widgets corresponding to the page 150 and display widget 151 may be provided for each container. Thus, a container 154, 156, and/or 158 may be related to a particular event such as a trip or wedding, a particular location such as a restaurant or museum, a particular company or divisions within a company, particular interests such as painting or a sport, or any other specialized interest that an owner of the container might define. For example, FIG. 12 depicts an exemplary embodiment of embedded containers within the container 154. In this embodiment, the container 154 contains content targeted toward car enthusiasts. In this embodiment, the data in the container 154 is organized based first on makers. Consequently, the containers 180, 182, and 184 correspond to the makers Porsche, Ford, and Lexus, respectively. Within each container 180, 182, and 184 different models for the maker are associated with containers. Consequently, the container 180 includes embedded containers 186, 188, and 190 for different models of Porsche. Each container 150, 180, 182, 184, 186, 188, and 190 may correspond to different pages 150. Moreover, display widgets 151 may subscribe to the containers 150, 180, 182, 184, 186, 188, and 190. The content in each container may be displayed as described above and below, added to, commented on, ranked, and displayed according to the preferences of the specific community adding to the container 150, 180, 182, 184, 186, 188, and 190. In addition, the containers may be ranked and displayed based upon the input (e.g. ranking) related to the containers themselves and/or individual items in the container. Thus, large or small, specific or general communities may be allowed to provide multimedia content and/or contribute to the evaluation of the multimedia content. The multimedia content in one or more containers and the containers themselves may be organized and displayed based on this evaluation in order to allow users easier access to content that is deemed superior by the relevant community. Moreover, by nesting containers, more specific communities (e.g. Porsche enthusiasts) may be linked with more general communities (e.g. car enthusiasts). Moreover, the preferences both the specific and general communities may be used in organizing content (e.g. higher ranked containers placed at the top of the car enthusiasts' container to reflect the preferences of car enthusiasts in general, while the items in the Porsche container may be ranked based on Porsche enthusiasts who rank items within the Porsche container). Thus, organization of content for specific and general communities may be improved.

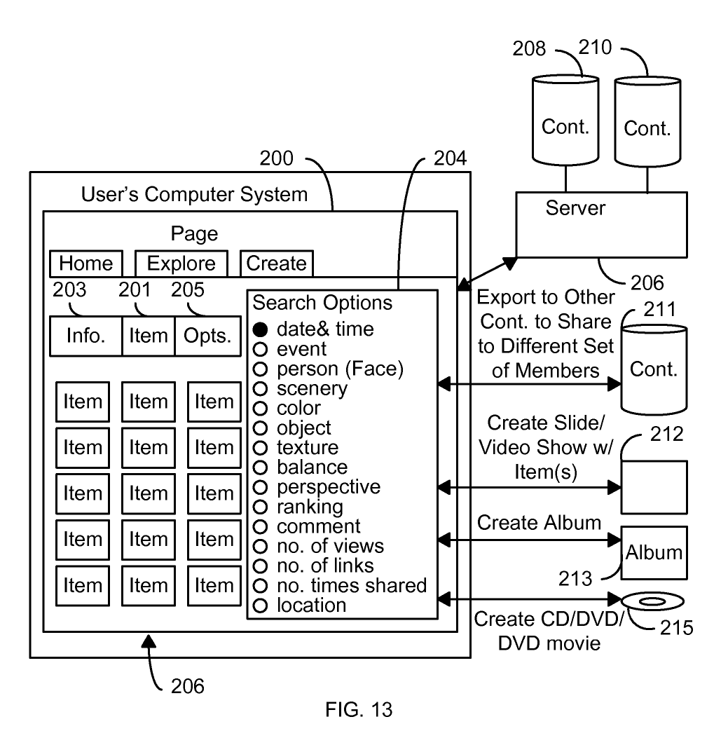

In using the system 100, content is displayed on the display widget 130/151. Particularly where the content available includes a large number of items, it is desirable to automatically select a subset of the content for presentation on the display widget. The image content selection subsystem 108 and the video content selection subsystem 110 are used to select such a subset of the content. FIGS. 13-19 depict exemplary embodiments of systems and methods for performing such selection, for example using the subsystem 108 and 110. Although described in the context of video and images, the method and system described in FIGS. 13-19 might be used for other content.

FIG. 13 depicts an exemplary embodiment of a portion of a system used for selecting a subset of content. The system displays at least a portion of the content on a page 200. The content displayed on the page 200 may be archived in container(s) 208 and 210 and accessible via server 206. A portion of the content selected may be displayed on a display widget 212, for example through a slide show or video clips. The display widget 212 may be analogous to the display widgets 130/151 and subscribes to the container 208 or 210. Also depicted on the page are items 206 stored in the corresponding container 208 or 210. In addition, examples search criteria 204 that may be selectable by a user are also depicted. For example, searches may be based on the date and time of the item, the event corresponding to the item, person(s) in the item, particular scenery or colors in the item, the objects in the item, textures in the item, the balance or perspective of the item, the ranking of the item, any comments made to the item, the number of times the item has been viewed, the number of links to the item, the number of times the item has been shared, and the location corresponding to the item. Also shown is a particular item 201 selected. Additional information 203 related to the item 201 and options 205 such as email, add as favorite or tag as offensive may also be shown. In addition, some of the other tasks which may be accomplished are also shown. These tasks include creation of an album 213, creation of a CD/DVD/DVD movie 215, and exporting of content to a different container 211, for example to share the content with a different set of individuals.

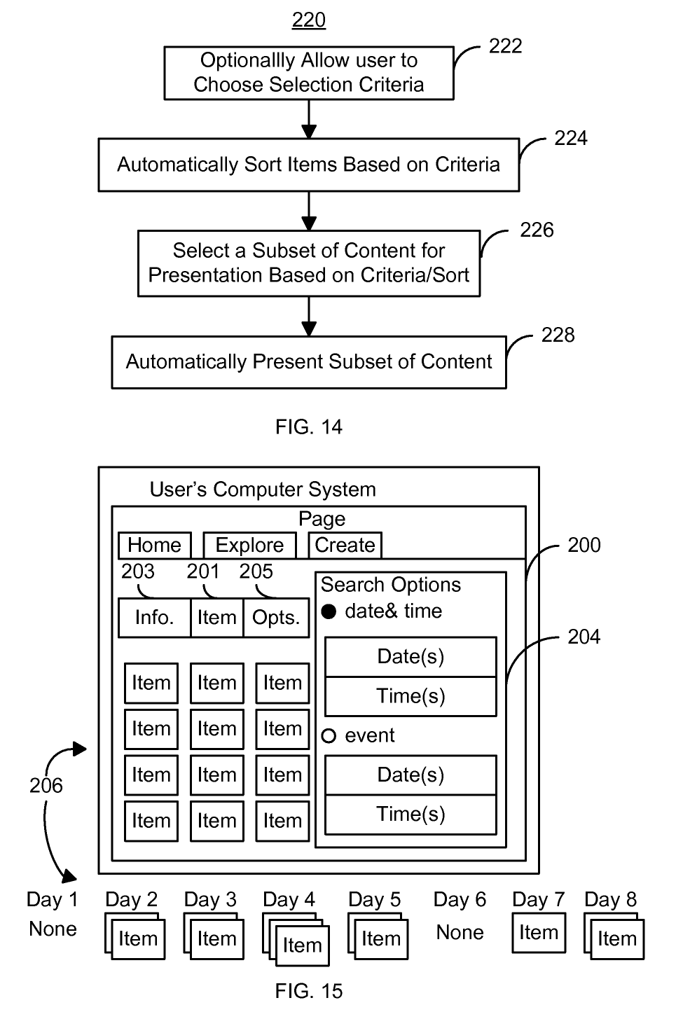

FIG. 14 is a high level flow chart of an exemplary embodiment a method 220 for automatically selecting a subset of the content to be displayed. The method 220 is described in the context of the system and the content of the container 208 depicted in FIG. 13. The method 220 may be automatically performed in order to periodically present content to the user.

A user may optionally be allowed to select from the search criteria 204, via step 222. One or more of the criteria 204 may be selected. However, if a user selection is not made, then one or more default criteria may be used. In addition, once selected, the criteria may be saved to select content to be displayed to a user multiple times. For example, a user may choose a particular event as the selection criterion. This event may be used as the selection criteria each time a subset of data is to be presented to the user until the criterion expires or new criteria are selected. Examples of search criteria may include image content such as faces, scenery, color, objects, texture, balance, and perspective; time stamps for items; event clustering based on the time stamp; meta-data that may be personally added by the owner of the container 208, community added and/or digital camera added; social feedback such as ranking, comments, tags, number of views, number of links, and number of times shared; and personal feedback of the owner of the container 208 such as ranking, comments, tags, number of views, number of links, and number of times shared.

The content of the container 208 is sorted based on the user-selected or default criteria, via step 224. A subset of the content is selected for display based on the criteria and the results of the sort performed, via step 226. Step 226 may also include filtering of content. For example, if images captured are separated by less than a particular threshold, then some images may be discarded as duplicates. Five images separated in time by five seconds may be considered duplicates. Thus, four of the images may be discarded. The remaining image will remain part of the subset of content selected for display. The selected content is automatically displayed, via step 228. Step 228 may include creating a photo album or photo set, a slide show or string of video channel played on the display widget 212, a multimedia set, or other set of related data automatically presented to the user. This display may be made at selected intervals, for example daily or hourly, for a user. Thus, the method 220 may automatically provide a subset of content to a user without requiring that the user go in and manually select individual images, video clips, or other data. Thus, the user may be presented with a manageable subset of archived content, allowing the user better access to the content and an opportunity to change the organization of content, for example culling images that are no longer desired.

Examples of sorting based on criteria may are depicted in the exemplary embodiments shown in FIGS. 15-17. FIG. 15 depicts the page 200 if the date and time and/or event are selected as the criteria for evaluating the items 206. If the criteria selected are the date and time only, then the content, such as the items 206, is sorted based on date and time and only the content for the particular date selected for display in step 226. If the criteria selected are an event on a particular date or having particular start and end dates and times, then content is sorted by proximity to these times in step 224. In the embodiment shown in FIG. 15, content is determined to be related to the event based on gaps in the time. For example, images or video captured on consecutive days before or after the event are considered part of the event. If there are one or more days (gaps) in which images or video are not captured, then items 206 captured before or after these gaps are considered not part of the event. Consequently, only the content not separated from the event by gaps is selected for display in step 226. In the embodiment shown in FIG. 15, if the item is on Day 4, then only the items on days 2-5 would be part of the event. The items captures on days 7 and 8 would not be part of the event. Thus, the items captured on days 2-5 may be selected and displayed in steps 226 and 228 of the method 220.

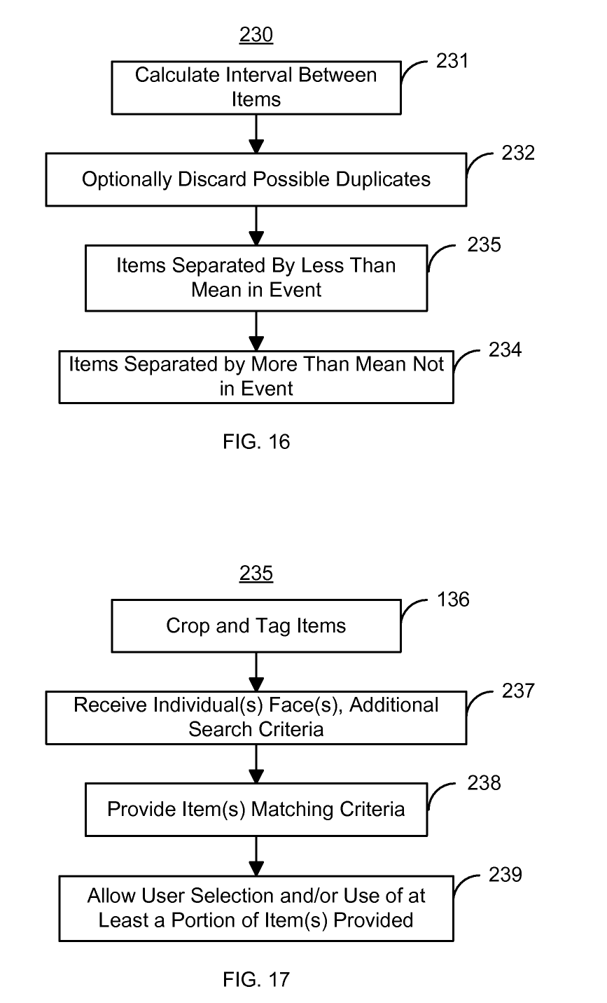

In another embodiment, the mean interval between items such as images in a set or video clips in a group of clips may be used in determining whether such items are part of the same event and thus whether such items might be included in a slideshow. FIG. 16 depicts an exemplary embodiment of a method 230 which utilizes the interval between items. The interval between items is determined, via step 231. In one embodiment, step 231 includes calculating a mean time between items. Possible duplicates may optionally be determined and discarded, via step 232. For example, images having capture times that are separated by less than a particular threshold are more likely to be duplicates. For example five images taken of the same scene and within five seconds of each other are likely duplicates. Consequently, four of the five images might be discarded. Thus, such items may not be considered for inclusion in the current slideshow. Items such as images or video clips separated in time by less than the mean interval are considered part of the same event and are selected for display in step 233. Images or video clips separated in time by greater than the mean interval are not considered part of the same event and are not selected for display via step 238. Thus, the method 230 may be considered to perform at least part of steps 24, 226 and 228 of the method 220 depicted in FIG. 14

For images and/or video, the selection may also be made based upon facial recognition. FIG. 17 depicts an exemplary embodiment of a method 235 for selecting items, such as images and/or video based on facial data. Faces in an image or video may be cropped at the time the image and/or video is imported or uploaded, via step 236. Also in step 236, the characteristics, or face feature set, of each cropped face may be tagged to the corresponding item and to cropped face. Again, this may take place prior to preparing to display the content to the user. When a person is selected as the criteria, for example in step 222 of the method 220, cropped faces may be displayed and the user allowed to choose one or more specific individuals as the search criteria, via step 237. Step 237 may thus include prompting a user to select one or more of the cropped faces as at least part of the search criteria. The item(s) including individuals having a feature sets closest to that of the selected individual are determined and, in one embodiment, provided to the user, via step 238. In one embodiment, the item(s) returned are ranked based on how well the search criteria are matched. Thus, the best matches may be displayed near the top of the page 200 or otherwise highlighted. The user may then select and/or use the item(s) returned, via step 239. In one embodiment, step 238 includes receiving the user's selection and, if the selection is made for other purposes, the purpose for which the item(s) are selected. For example, the user may indicate specific images that are desired to be archived in another container (not shown), made part of a slideshow, made part of an album, or used for another purpose. Thus, the user may be better able to access items including persons.

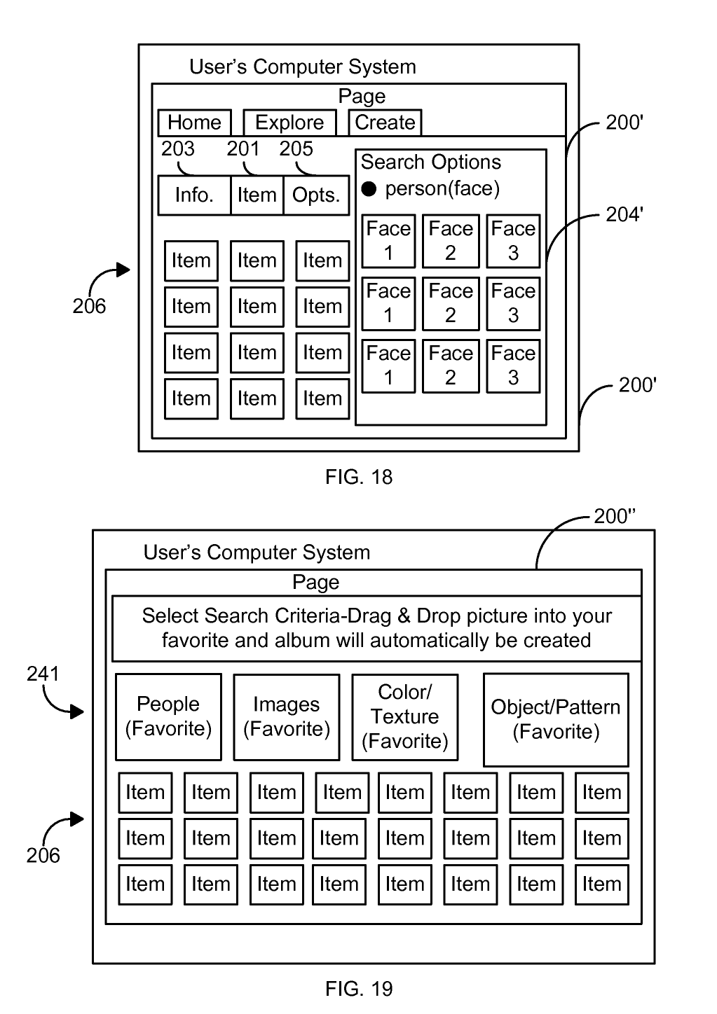

FIGS. 18-19 depict other exemplary embodiments of graphical user interfaces for pages 200′ and 200″ that allow for user selection of criteria, such as particular faces. Thus, the pages 200′ and 200″ correspond to special cases of the page 200. In the page 200′, the user may be prompted to make a selection. Thus, the user may select one or more of the faces 204′ from the items 206. The faces 204′ may be of a single individual or of multiple individuals. In the page 200”, the user is prompted to make their selection by dragging and dropping one or more of the items 206 into the desired location 241.

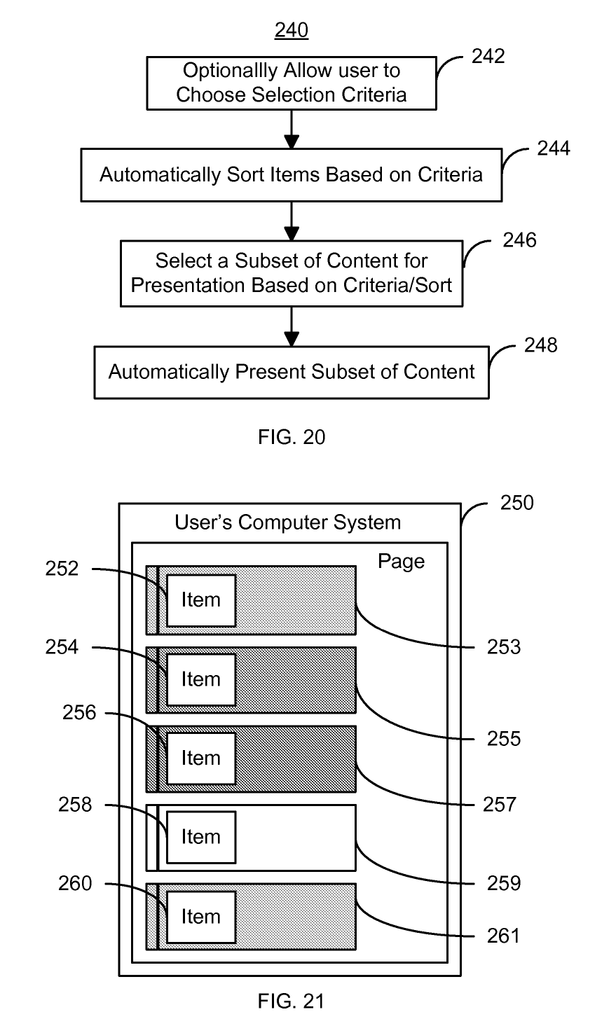

Similarly, a subset of audio content may be automatically selected and presented to the user via audio content subsystem 112. FIG. 20 depicts a flow chart of an exemplary embodiment a method 240 for automatically selecting a subset of the audio content to be displayed. The method 240 may be automatically performed in order to periodically present audio content to the user.

A user may optionally be allowed to select from the search criteria, via step 242. One or more of the criteria 204 may be selected. However, if a user selection is not made, then one or more default criteria may be used. In addition, once selected, the criteria may be saved to sort and display content to a user multiple times. Examples of selection criteria include audio content such as beats per minute, tone, tempo, and musical style; time stamp of the audio content; event clustering similar to that described above that is based on the audio time stamp; meta-data that may be personally added by the owner of the container 208, community added, computer added, and audio device added; social feedback such as ranking, comments, tags, number of views, number of links, and number of times shared; and personal feedback of the owner of the container 208 such as ranking, comments, tags, number of views, number of links, and number of times shared.

The content of the container 208 is sorted based on the criteria, via step 244. A subset of the content is selected for presentation based on the criteria and the results of the sort performed, via step 246. Step might also include filtering of content, for example to limit or preclude duplicate audio samples from being played. The selected content is automatically presented to the user, via step 248. Thus, step 248 plays a smaller subset of the audio selections archived in a container. As a result, the method 240 may effectively create a social “radio” station or music collection for the user.

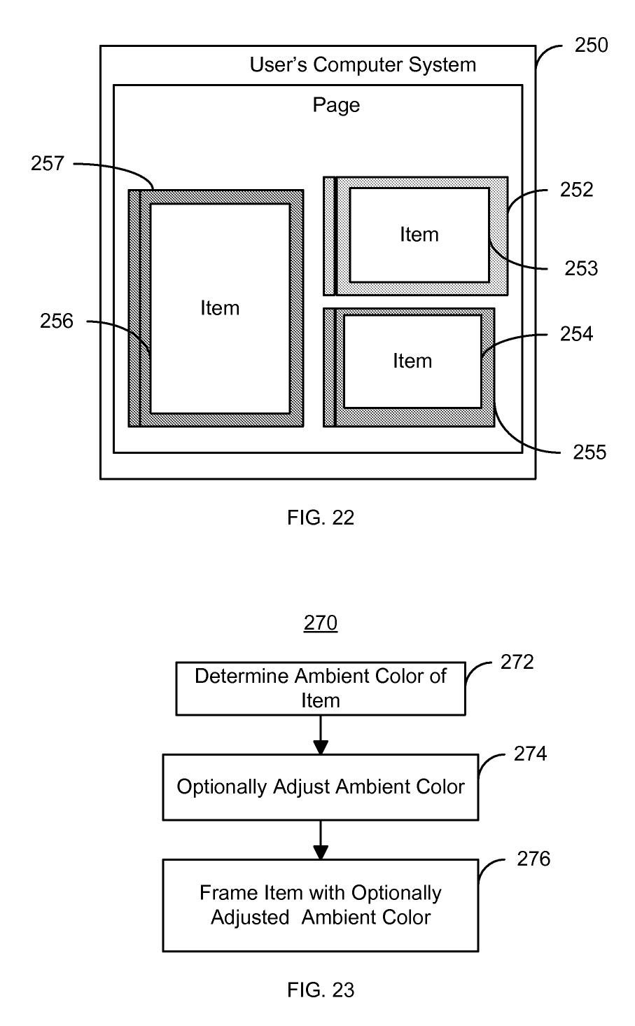

In order to present visual content to the user, for example images or video using the system 100, the ambient color framing subsystem 114 may be used. The ambient color framing subsystem may, for example, be used in displaying individual items on the page 150 or 200. FIGS. 21-25 depict exemplary embodiments of systems and a method for determining and displaying items utilizing ambient color framing. Individual items, such as images or video clips, may be desired to be framed on a web page. For example, FIG. 21 depicts a web page 250 that may present items 252, 254, 256, 258, and 260 or items 262, 264, and 266 in different configurations. In order to improve the look of the page 250, the items 252, 254, 256, 258, 260, 262, 264, and 266 may be desired to be framed. Consequently, one or more of the items 252, 254, 256, 258, 260, 262, 264, and 266 may be displayed in the frames 253, 255, 257, 259, 261, 263, 265, and 267, respectively. These frames 253, 255, 257, 259, 261, 263, 265, and 267 reflect the ambient color of the items 252, 254, 256, 258, 260, 262, 264, and 266. Stated differently, the frames 253, 255, 257, 259, 261, 263, 265, and 267 have a color that is based on a mean or average color of the items 252, 254, 256, 258, 260, 262, 264, and 266. Consequently, the frames 253, 255, 257, 259, and 261 are depicted as having different shades which depend upon the colors (including shades for black-and-white) in the corresponding item 252, 254, 256, 258, and 260, respectively.

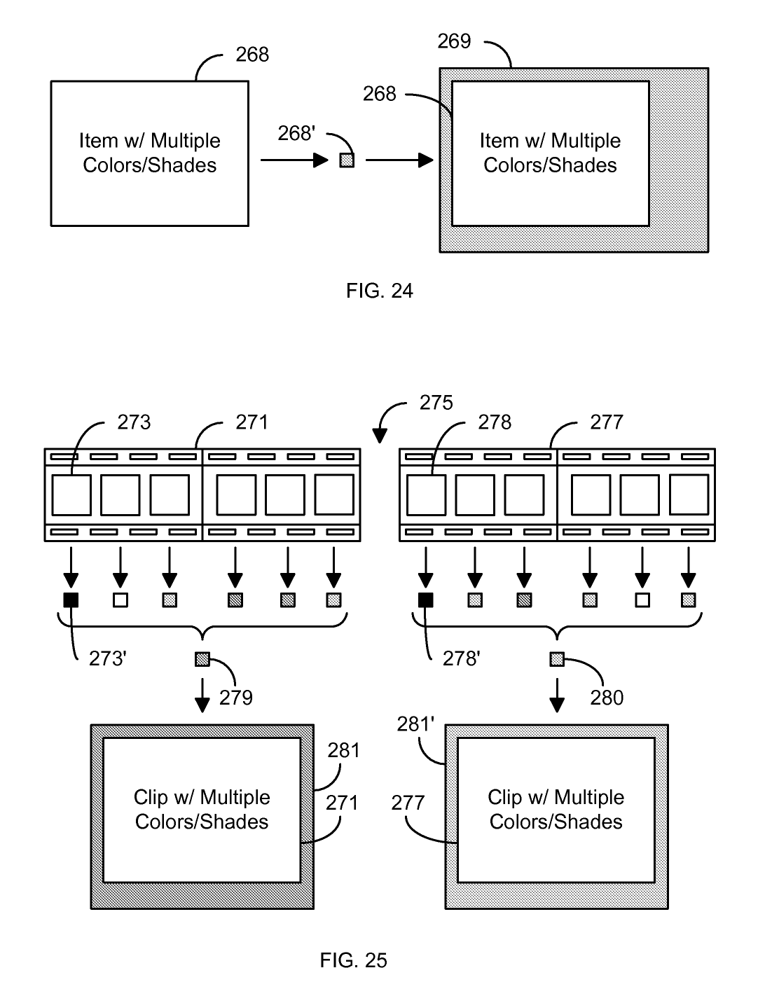

FIG. 23 depicts an exemplary embodiment of a method 270 for displaying visual items with ambient color framing. The ambient color for items being displayed with such framing is determined, via step 272. In one embodiment, the ambient color for an image is determined based on a photo histogram that indicates the colors of the photo. The ambient color for each image is the average or mean color of the histogram. Examples of frames 253, 255, 257, 259, and 261 that may be determined using such an ambient color determination are depicted in FIG. 21. However, such a method of determining ambient color may be CPU intensive. Consequently, in another embodiment, the ambient color may be determined by shrinking an image to a smaller size and determining the ambient color for this smaller size. In one embodiment of such a method, the size is one pixel by one pixel. Thus, the ambient color would simply be the color of this pixel. Such an exemplary embodiment is depicted in FIG. 24 for an item 268 and the frame 269. The item 268 is shrunk to a smaller size 268′. In the embodiment shown, the item 268′ is a one-by-one, or single pixel having a single, average color. The ambient color may be the average color of this single pixel or the average color after optional adjustments. The ambient color is then applied to the frame 269. For video, the ambient color may be determined for each frame. The ambient color for a number of frames, for example all of those in a particular clip, may then be averaged to obtain a single ambient color. The ambient color for video may, therefore, change at transitions. Such an exemplary embodiment is depicted in FIG. 25. The clips 271 and 277 have frames 273 and 278, respectively, and are separated by a transition 275. For clarity, only one frame 273 and 277 is marked in each clip 271 and 277, respectively. Each frame 273 and 277 may be shrunk to a smaller size 273′ and 277′, respectively. In one embodiment, the size 273′ and 277′ is each a single pixel. The color of the single pixel 273′ and 277′ may be combined to provide a single color 279 and 280, respectively. These colors 279 and 280, optionally adjusted, may then be applied to at least part of the frame 281 and 281′, respectively. Thus, the frame will have one color 281′ while the clip 271 plays but may have another color 281′ while the clip 277 plays. However, in another embodiment, a single ambient color might be determined for all video shown in a particular loop.

Referring back to FIGS. 21-25 and more particularly FIG. 23, the ambient color may then be adjusted, via step 274. For example, the ambient color may be lightened a particular amount or adjusted based on display preferences or other content being displayed. The visual content is then displayed framed using the corresponding ambient color, via step 276. Thus, the images 252, 254, 256, 258, 260, 262, 264, and 266 may be displayed in the frames 253, 255, 257, 259, 261, 263, 265, and 267, respectively, having the corresponding ambient color.

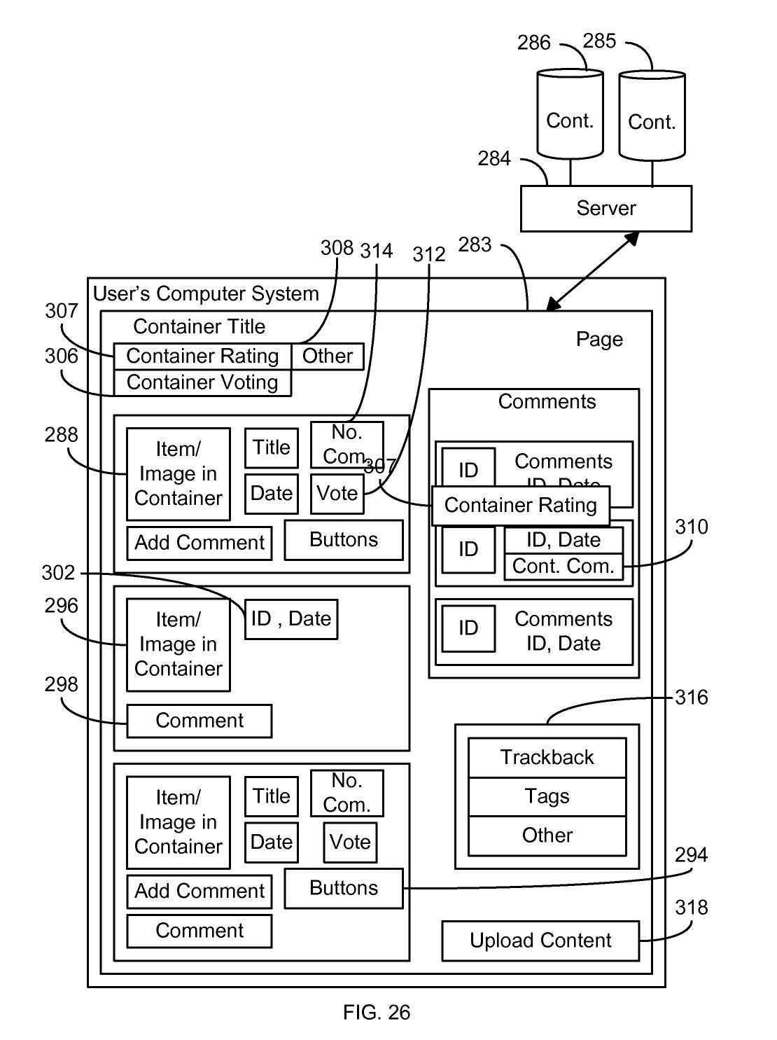

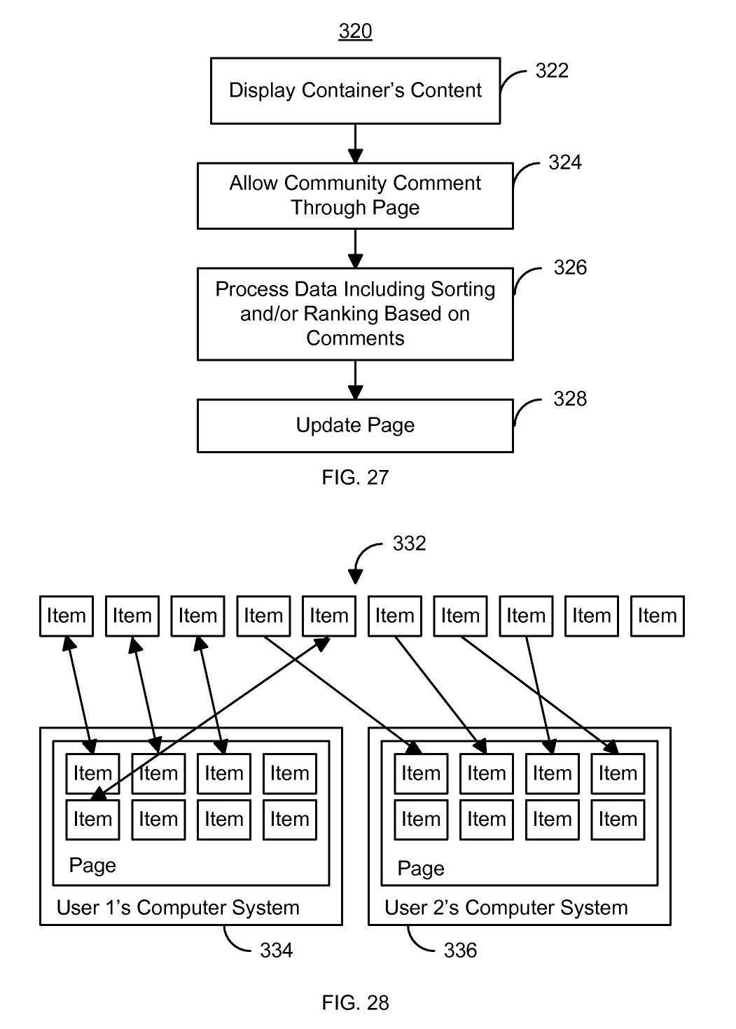

The system 100 may also use the comment and rating subsystem 116. Although shown separately for the purposes of discussion, the comment and rating subsystem 116 may also be incorporated into the social content aggregation subsystem 106 or other relevant subsystem. FIGS. 26-28 depict exemplary embodiments of a system and method for use in comment and rating, particularly be a community that can be used as a distributed human computing engine. Referring to FIGS. 26-28, a web page 283 may be used to display content in containers 285 and 286, via a server 284 and using the method 320. In addition, the mechanisms discussed above, for example with respect to FIGS. 1-12, may also be used. Utilizing the method 320 for determining image popularity based on community commenting, tagging, voting or ranking of a set of images.

Content in the container, such as the container 285, is displayed, via step 322. Both items archived in the container and information relating to the item may be displayed. For example, the page 283 displays items 288 and 296 which, in the embodiment shown, are images 288 and 296. In addition, comments 298 for individual items, comments for the container 31 0, a rating for the container 307, the date and user of the comment 302, the number of votes 314, and/or other information may be displayed. Although not depicted, a display widget such as the display widgets 130 and 150 may also be provided on the page 283.

A user is allowed to provide input regarding the container, via step 324. For example, the page 283 includes interfaces for item voting 312; buttons 294 for adding comments to, sending emails regarding, or marking individual items as offensive; interface 308 for adding comments to, marking as offensive, or emails regarding the entire container; and voting on the entire container 306. In one embodiment, such input may be controlled. For example, a user may be allowed to vote only once for a particular item or container to preclude a single user from skewing the results. The user may also tag the container or items in it via interface 316. Authorized users may also upload items directly to the container 285 via interface 318. Thus, significant user interaction is allowed through the page 283 in step 324. As a result, input from a community of users may be accepted.

The input from the user is processed, via step 326. For example, the ranking of the container may be updated and comments added to items. Items already in the container may also be processed for display based on the user's comments. For example, items marked by the user as offensive my be set not to be displayed and the size of items may be changed based on their ranking as described below. Moreover, items added by the user processed for display, for example by providing an ambient color frame or selecting portions of the content for viewing as discussed above or sizing as discussed below.

The page 283 is updated to reflect the additional input, via step 328. Consequently, changes to the ranking, additional comments, and new items may be displayed. In addition, the items may be displayed in order based upon their ranking, allowing the community-determined best content to be more easily viewed. Further, as discussed below, the sizes or other features of items may be set based upon the input such as the items' rankings. Items that have not yet been rated may be more prominently displayed in order to facilitate their ranking.

Thus, as depicted in FIG. 28, the system 100 particularly through the method 320, page 283 and system depicted in FIGS. 1-12 may provide a distributed human computing engine formed by the users. The distributed human computing engine allows objects in the containers 285 and 286 to be viewed and rated. In particular, the items 330 to be provided to the users computer systems 332 and 334. In addition, if they chose, users may provide feedback related to items 330 viewed. The system 100 may utilize the feed back to organize and display content. Content may, therefore, be organized across a collection of individuals, allowing the community-determined best and worst content to be treated in the desired fashion.

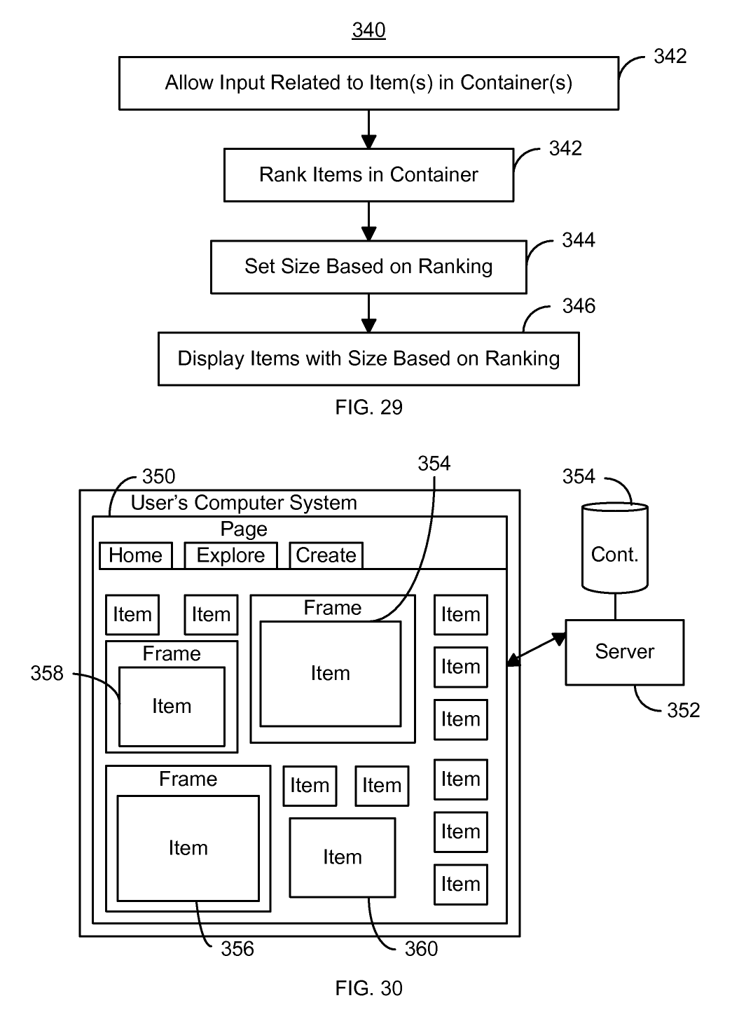

As discussed above, content may be displayed based on its ranking using the ranking playback subsystem 118. FIGS. 29-30 depict exemplary embodiments of a method 340 and system for displaying content based on its ranking. The method 340 and system are described in the context of images. However, one of ordinary skill in the art will readily recognize that the method 330 and system may be applied to other content including but not limited to video and text.

Referring to FIGS. 29-30, users are allowed to provide input from various systems, via step 342. The input may include comments, ranking voting, or other input related to the items stored in the container 354. The items in a container 354 are ranked by the server 352, via step 344. Step 344 may include determining the number of votes for each item, then ranking the items from highest to lowest number of votes. Alternatively, another measure of popularity such as number of times viewed or emailed, or a combination of factors may be used to rank the items. The items are sized based on their ranking, via step 346. In one embodiment, the items are ranked from most popular (e.g. highest number of votes) to least popular. The items are displayed on the page 350, via step 348. In one embodiment, the items are fit into a template having different sized regions for items having different rankings. Thus, the highest ranked items 354 and 356 have the largest size on the page 350, while the less popular items have a smaller size. Note that although items 354 and 356 have the same size, they may not have equal popularity. Instead, they may be the two highest ranked items. Similarly, the smaller items having the same size, such as items 358 and 350 need not have equal rank. Instead, items 358 and 360 have the next two highest ranks. Thus, the items in a container 354 may be displayed based on their ranking by an individual user or a community. Consequently, organization of content in the container 354 is facilitated.

Thus, a system and method for managing and maintaining content, particularly over the Internet have been described. The method and system have been described in accordance with the exemplary embodiments shown, and one of ordinary skill in the art will readily recognize that there could be variations to the embodiments, and any variations would be within the spirit and scope of the method and system. Software written according to the method and system is to be stored in some form of computer-readable medium, such as memory, CD-ROM or transmitted over a network or other medium, and executed by a processor. Accordingly, many modifications may be made by one of ordinary skill in the art without departing from the spirit and scope of the appended claims.

We Claim:

1. A system for displaying content comprising:
a display widget embeddable on a page, the display widget for receiving content pushed to the display widget and for providing input regarding the content, the display widget including a player for playing the content provided to the display widget, the display widget providing content to the page and allowing for uploading of content from the page.

2. A system for providing content to a page comprising:
at least one container for storing content;
an interface including a first module for pushing content to the page and a second module for listening for input from the page;
a plurality of commands for accessing the content in the container and providing the content to the page based on the input from the page.

3. The system of claim 2 wherein the content includes a plurality of individual items, the system further comprising:
a social content aggregation subsystem for accepting user input regarding the plurality of individual items from at least one user and sorting the plurality of individual items based on the user input.

4. The system of claim 2 wherein the input further includes at least one of comments and voting on the plurality of items.

5. The system of claim 2 further comprising:
at least one display widget for playing the content, the at least one display widget being located remote from the container, the interface, and the plurality of commands.

6. The system of claim 2 wherein the interface includes an HTTP protocol module for pushing data to the page and an XML-RPC module for listening for the input from the page.

7. The system of claim 2 wherein the container is restricted to a plurality of authorized users for at least one of viewing the content and adding to the content.

8. The system of claim 3 wherein the interface and the plurality of commands reside in a server.

9. The system of claim 8 wherein the other device further includes at least one of a cellular telephone, a digital camera, and a television.

10. A computer-implemented method for displaying content comprising:
allowing a display widget to be embedded on a page, the display widget for receiving content pushed to the display widget and for providing input regarding the content, the display widget including a player for playing content provided to the display widget, the display widget providing content to the page and allowing for uploading of content from the page.

11. A computer-implemented method for providing content to a page comprising:
allowing at least one container for storing content to be defined, the allowing including at least one of allowing at least one item of the content to be placed in the container and determining at least one authorized user for at least one of viewing the content and adding to the content;
listening for input from the page using a first module;
executing at least one of a plurality of commands based on the input, the at least one command for accessing the content in the container and providing the content to the page based on the input from the page.

12. The computer-implemented method of claim 11 wherein the content includes a plurality of individual items, the method further comprising:
accepting user input regarding the plurality of individual items from at least one user; and
sorting the plurality of individual items based on the user input.

13. The computer-implemented method of claim 12 wherein the user input further includes at least one of comments and voting on the plurality of items.

14. The computer-implemented method of claim 12 wherein the allowing further includes using interface includes an HTTP protocol module for pushing data to the page and using an XML-RPC module for listening for the input from the page.

15. The computer-implemented method of claim 11 wherein the executing further includes:
determining whether each of the at least one item corresponds to an event based on at least one time associated with the at least one item.

16. A computer-implemented method for providing content to a page, the content including a plurality of items stored in a container, the method comprising:
displaying at least one of the plurality of items;
allowing a user to provide input regarding at least a portion of the plurality of items;
sorting the plurality of items based on the input; and
displaying the plurality of items based on the input.

17. The computer-implemented method of claim 16 wherein the user input further includes at least one of comments and voting on the plurality of items.

18. The computer-implemented method of claim 16 wherein the allowing further includes using interface includes an HTTP protocol module for pushing data to the page and using an XML-RPC module for listening for the input from the page.

19. A computer-readable medium including a program for displaying content, the program including instructions for:
allowing a display widget to be embedded on a page, the display widget for receiving content pushed to the display widget and for providing input regarding the content, the display widget including a player for playing content provided to the display widget, the display widget providing content to the page and allowing for uploading of content from the page.

20. A computer-readable medium including a program for providing content to a page, the program including instructions for:
allowing at least one container for storing content to be defined, the allowing including at least one of allowing at least one item of the content to be placed in the container and determining at least one authorized user for at least one of viewing the content and adding to the content;
listening for input from the page using a first module;
executing at least one of a plurality of commands based on the input, the at least one command for accessing the content in the container and providing the content to the page based on the input from the page.
